(19) United States
(12) Patent Application Publication
(10) Pub. No.: US 2026/0275789 A1
(43) Pub. Date: Sep. 17, 2026

(54) MONITORING SYSTEM COMPRISING A DOOR CLOSER

(71) Applicant: DORMAKABA DEUTSCHLAND GMBH, Ennepetal (DE)

(72) Inventors: Alexander HELLWIG, Ennepetal (DE); Sven BUSCH, Ennepetal (DE); Lothar BALTES, Ennepetal (DE); Gökhan AKGÜN, Ennepetal (DE)

(21) Appl. No.: 19/474,062

(22) PCT Filed: Apr. 4, 2024
(86) PCT No.: PCT/EP2024/059220

§ 371 Date: Oct. 9, 2025

(30) Foreign Application Priority Data
Apr. 10, 2023 (EP) 23167233.8

(51) Int. Cl. E05F 1/10; G01B 7/30; G01D 5/14; G08C 17/02

(52) U.S. Cl. CPC E05F 1/1041; G01B 7/30; G01D 5/145; G08C 17/02; E05Y 2201/11; E05Y 2201/626; E05Y 2201/638; E05Y 2400/32; E05Y 2400/612; E05Y 2400/66; E05Y 2900/132

(57) ABSTRACT

A monitoring system including a door closer for closing a door, with a housing and an output shaft supported therein, designed for fastening a lever arrangement, with a mechanical energy storage device in the housing, which drives the output shaft to rotate in a closing direction of rotation, with the energy storage device preferably being a spring, with the output shaft being able to rotate into a first angle range, which can be used to open and close the door, and in a second angle range, with a sensor unit for detecting an actual angle of rotation dependent on the angle of rotation of the output shaft, and an evaluation unit, with the evaluation unit being designed to generate a message when the actual angle of rotation is in the second angle range.

### CROSS-REFERENCE TO RELATED APPLICATIONS

This application is a 35 U.S.C. § 371 National Stage patent application of PCT/EP2024/059220 filed 4 Apr. 2024, which claims the benefit of European patent application 23167233.8 filed 10 Apr. 2023, the disclosures of which are incorporated herein by reference in their entirety.

### TECHNICAL FIELD

The present disclosure relates to a monitoring system comprising a door closer for closing a door. Furthermore, the disclosure shows a method for monitoring a door closer.

### BACKGROUND

EP 3 315 704 A1 shows a system for monitoring safety-relevant functions of a door closer. A combination of position and acceleration signals is used to verify whether the door closer has been broken or tampered with. For example, it can be detected whether a lever connected to the output shaft of the door closer has been unhooked.

### SUMMARY

The present disclosure provides a monitoring system that enables a door with a door closer to be used safely by simple means-in particular simple manufacture and low-maintenance operation. The monitoring system is in particular intended to detect whether the door closer or the lever arrangement has been broken or tampered with. A method for operating the monitoring system will also be indicated.

This is achieved by providing the features of the independent claims. The dependent claims relate to preferred configurations of the disclosure.

The disclosure shows a monitoring system. The monitoring system comprises a door closer for closing a door and an evaluation unit.

The door closer has a housing. The housing is in particular made of metal, preferably cast. An output shaft of the door closer is supported in the housing so as to be rotatably movable. The output shaft can be rotated about an axis of rotation.

The output shaft is designed for fastening a lever arrangement. According to a first mounting variant, the door closer can be fastened on the door, i.e. on the door leaf. The lever arrangement forms the connection to the wall. For example, a slide rail of the lever arrangement is fastened to the wall. In the context of the present disclosure, the term “wall” also includes the door frame. According to a second mounting variant, the door closer can be fastened to the wall. The lever arrangement then forms the connection from the door closer to the door, i.e. to the door leaf. For example, the slide rail of the lever arrangement is fastened on the door, i.e. on the door leaf.

The door closer comprises a mechanical energy storage device. The mechanical energy storage device is designed in particular as a spring. A spiral spring is particularly preferred. The mechanical energy storage device is arranged in the housing and drives the output shaft to rotate in a closing direction of rotation. As will be described in detail, a transmission unit can be located between the energy storage device and the output shaft in order to convert between the movement of the output shaft and the movement of the energy storage device, in particular in order to convert a movement of the energy storage device into a movement of the output shaft.

The output shaft rotates in the “closing direction of rotation”, in particular when the door closer is properly installed to close a door and the door closes. When the door is opened, the output shaft rotates in the opposing direction, also known as the opening direction of rotation.

The door closer is preferably designed without a drive such that it is in particular not a door drive operated in a motorised manner.

It can be provided that the door closer comprises hydraulic oil to dampen the closing movement.

In the context of the present disclosure, it is defined that the output shaft rotates within a first angle range to open and close the door. This first angle range must be distinguished from a second angle range. The output shaft can be rotated into the second angle range. However, the second angle range is not occupied by the output shaft as long as the door closer is properly installed on the door and in operation. If the door closer is not installed, the output shaft rotates in the second angle range in particular, as this discharges the energy storage device as far as possible.

When installing the door closer, the lever arrangement is mounted on the output shaft and the output shaft is rotated to the first angle range via the lever arrangement. If the door closer is installed, the lever arrangement is always connected to the output shaft on one side and to the wall or door on the other. As a result, the output shaft can rotate at most up to the limit between the first angle range and the second angle range. However, the output shaft does not rotate into the second angle range.

This means in particular that the limit between the first angle range and the second angle range represents a “closed position” of the output shaft. In this closed position of the output shaft, the associated door is closed. The angle for the closed position of the output shaft is referred to as the “closing angle of rotation”.

If damage now occurs to the door closer or the lever arrangement or, for example, the lever arrangement is tampered with, in particular if the lever arrangement is detached, the output shaft rotates from the first angle range into the second angle range.

The door closer also comprises a sensor unit that is designed and arranged to detect an actual angle of rotation. This actual angle of rotation depends on the angle of rotation of the output shaft. The actual angle of rotation is preferably the angle of rotation of the output shaft.

The monitoring system comprises the evaluation unit. As will be described in detail, this evaluation unit does not have to be located in the door closer, but can also be located at any other point. The evaluation unit is preferably electronic. The evaluation unit preferably comprises an electronic processor and/or an electronic memory.

The evaluation unit is in particular designed to receive the actual angle of rotation from the sensor unit. One or a plurality of limit values that characterise the second angle range are stored in the evaluation unit. The evaluation unit is designed to compare the actual angle of rotation received with the limit value(s) for the second angle range stored in the evaluation unit. The at least one limit value can be fixedly predefined in the electronic memory during operation. At least one limit value can be fixedly predefined before installation. Alternatively, at least one limit value can be set during installation. The at least one limit value can be determined by a learning process, in particular after installation.

The evaluation unit is designed to generate a message if the actual angle of rotation is in the second angle range; the generation of the message is therefore dependent on whether or not the actual angle of rotation is in the second angle range.

The message is, for example, a signal that the evaluation unit generates and uses within itself, for example to issue a warning, and/or that the evaluation unit transmits to another unit. Based on the message that is generated in the evaluation unit, it can be concluded that the damage or tampering described above has occurred. This in turn leads to the conclusion that the door may not be properly closed by means of the door closer, which is relevant in particular for fire doors.

For example, the closing angle of rotation is stored in the evaluation unit, which means that the limit between the first angle range and the second angle range is known in the evaluation unit. This means that the closing angle of rotation can correspond to a limit value. This closing angle of rotation can, for example, be a value fixedly stored in the evaluation unit or a value that can be changed depending on the installation situation of the door closer. It is also possible to define the closing angle of rotation in the evaluation unit by way of a corresponding learning process after the door closer has been installed.

It is preferably provided that the door closer comprises a mounting plate and the housing of the door closer is fastened to the mounting plate. The mounting plate preferably comprises fastening elements, in particular in the form of holes, to screw the mounting plate to the door or wall and to fasten the housing and any other elements to the mounting plate.

It is preferably provided that the door closer comprises a panel. The panel covers at least the housing of the door closer. The panel is preferably fastened to the mounting plate.

The panel preferably has two opposing end walls. The end walls are preferably connected to one another via two opposing side walls. It is in particular provided that the two end walls and the two side walls together form the base body of the panel. This base body of the panel can preferably be closed by means of a removable cover of the panel.

It is preferably provided that the door closer is designed to rotate the output shaft into the second angle range as soon as a connection-in particular the lever arrangement-between the output shaft and the door or between the output shaft and the wall is detached. It should be noted in particular that the lever arrangement connects the output shaft to the door if the door closer is fastened to the wall or the lever arrangement connects the output shaft to the wall if the door closer is fastened to the door.

In addition, it is preferably provided that the output shaft in its closed position, i.e. when the door is closed, is driven by the energy storage device to rotate, in particular in the closing direction of rotation. This means in particular that the output shaft is still driven by the energy storage device in its closed position and the energy storage device is not completely discharged. This ensures in particular that the energy storage device can still rotate the output shaft from the closed position into the second angle range.

When the output shaft rotates in the closing direction of rotation, the pretension of the energy storage device or the energy stored in the energy storage device decreases, with it being provided in particular that a minimum pretension is not present in the energy storage device in the closed position, but only in the second angle range. A minimum pretension also includes the absence of a pretension.

The output shaft can preferably be rotated in the opening direction of rotation to charge the energy storage device when the door is opened. The door is opened in particular by manual actuation of the door, in particular by a user.

The sensor unit preferably comprises a sensor and an encoder. The encoder is preferably arranged or designed on the output shaft. The encoder is preferably a separate component that is arranged, in particular fastened, to the output shaft. Alternatively, the output shaft can also be designed in such manner that it acts as an encoder.

The sensor of the sensor unit is designed to identify the encoder, in particular without contact. The sensor is particularly preferably designed to detect a position and/or a rotation and/or an acceleration of the encoder. It is in particular provided that the combination of sensor and encoder makes it possible to detect the actual angle of rotation of the output shaft.

The arrangement of the encoder directly or indirectly only one encoder fastening on the output shaft has the advantage that the encoder and thus the entire sensor arrangement can be added to existing door closers. The necessary approvals usually already exist for such existing door closers such that no or only minor changes to the approval are required by adding the sensor unit. This is due in particular to the fact that the relatively small encoder does not affect the mechanics inside the door closer and therefore the basic function of the door closer, namely to close the door securely, is not affected by the sensor unit.

It is preferably provided that the encoder comprises a permanent magnet and the sensor is a magnetic sensor, in particular a Hall sensor.

The permanent magnet is preferably designed in such manner that the north pole forms one end of the permanent magnet and the south pole forms the other end of the permanent magnet. When the encoder rotates, the north and south poles change position in space. For example, the permanent magnet is round and the north pole and the south pole each form one half of the permanent magnet.

The encoder is preferably fastened to the end face of the output shaft. The encoder is particularly preferably fastened, in particular screwed, to the output shaft in a form-fitting and/or force-fitting manner. The output shaft particularly preferably has a fastening receptacle on at least one side, in particular on both sides. This fastening receptacle is in particular a bore coaxial to the axis of rotation of the output shaft. The fastening receptacle particularly preferably has an internal thread.

An encoder fastening is preferably inserted, in particular screwed, into the fastening receptacle. The encoder fastening has a fastening head. The encoder is preferably fastened, in particular adhered, on the fastening head.

In a preferred embodiment, the fastening head has a form-fitting element that ensures the precise positioning of the encoder. In addition, it is preferably provided that the fastening head has an edge surrounding the encoder such that the edge also ensures that the encoder is fastened on the fastening head in the precise position.

The encoder fastening is preferably made of plastic.

The axis of rotation of the output shaft preferably intersects the sensor and/or the encoder. This ensures that an arrangement of sensor and encoder is as close as possible to the axis of rotation, enabling precise detection of the actual angle of rotation in the tightest of spaces.

The sensor is particularly preferably arranged symmetrically to the axis of rotation, whereby the axis of rotation intersects the sensor, in particular in the centre of the sensor. It is also preferably provided that the encoder is arranged symmetrically to the axis of rotation, whereby the axis of rotation intersects the centre of the encoder, in particular a dividing line between the north and south poles.

The output shaft is preferably exposed on two opposing sides of the housing and is used to optionally fasten the lever arrangement to one side or the other side. It is provided that the lever arrangement can be fastened to both sides of the output shaft, but—as described by the term “optional”—is only actually fastened to one of the two sides.

The output shaft in particular has a polygon, in particular a square, on each of the two opposing, exposed sides for fastening the lever arrangement.

The monitoring system described particularly preferably comprises the lever arrangement. The lever arrangement can also be regarded as a component of the door closer. The lever arrangement is fastened to one side of the output shaft and the encoder is fastened to the other side of the output shaft. This means that the side of the output shaft not used for the lever arrangement can be used for the sensor arrangement.

The lever arrangement preferably comprises a slide rail and a lever, whereby one end of the lever is guided in the slide rail and the other end of the lever can be fastened to the output shaft.

Alternatively, the lever arrangement preferably comprises a linkage, with the linkage having two rods rotatably connected to one another. One end of the linkage can be fastened to the output shaft. The other end of the linkage can be fastened to the wall so as to be rotatable if the door closer is mounted on the door or can be fastened to the door so as to be rotatable if the door closer is mounted on the wall.

As described, the encoder is preferably located on the output shaft and rotates with the output shaft. In contrast, the sensor is installed stationary, but is preferably located in the immediate vicinity of the encoder, in particular on the end face of the output shaft.

It is preferably provided that the sensor is arranged on a sensor receiving arrangement. The sensor receiving arrangement preferably positions the sensor on the end face of the output shaft.

The sensor receiving arrangement preferably comprises a bracket. The bracket is in particular in one piece. The bracket is preferably made of plastic.

It is preferably provided that the sensor receiving arrangement comprises a sensor circuit board. The sensor is arranged on the sensor circuit board and the sensor circuit board is preferably fastened to the bracket.

The sensor receiving arrangement, in particular the bracket, is preferably fastened, in particular screwed, to the mounting plate. This makes it possible to position the sensor relatively fixedly and accurately.

Additionally or alternatively, the sensor receiving arrangement can rest against and/or be fastened to the housing of the door closer. The fastening relative to the housing in particular enables very precise positioning of the sensor relative to the encoder, which is located on the output shaft.

The bracket preferably has a bracket projection. This extends around the output shaft such that the output shaft protrudes into the bracket projection.

The bracket projection is preferably supported axially on the inside against the housing. This means that the bracket rests against the housing.

The bracket projection preferably clamps radially on the outside of an inner surface of the housing, whereby the bracket is fastened to the housing.

Additionally or alternatively, the sensor receiving arrangement can rest against the inside of the panel. The bracket is preferably clamped between the panel and the housing. This provides a further option for positioning the sensor receiving arrangement and thus the sensor accurately and with as little play as possible.

The sensor receiving arrangement preferably comprises at least one fastening spring, in particular as an integral part of the bracket, in order to apply pretension to the clamped bracket.

The panel preferably comprises at least one bracket receptacle for the bracket. The panel preferably comprises fastening tabs, with the fastening tabs being recessed on the bracket receptacle for inserting the bracket. The panel can be fastened to the mounting plate, in particular screwed, by means of these fastening tabs.

The bracket receptacle is preferably doubled on the inside of one of the two side walls of the panel. This double design of the bracket receptacle is used in particular when the housing is changed between a left-sided arrangement and a right-sided arrangement, as will be explained in detail.

As already mentioned, the evaluation unit is designed in particular to relay the generated message to an external unit. This unit can be a building control unit and/or a cloud and/or a server and/or a terminal and/or a mobile terminal. The terminal is a computer, for example. The mobile terminal is a smartphone or tablet, for example.

By relaying the message from the evaluation unit to the external unit, a corresponding warning can be generated in the unit in any desired manner. For example, the mobile terminal can be used to indicate that a certain door closer has been damaged or tampered with.

According to an optional first variant, it is provided that the evaluation unit generating the message is arranged in the region of the door, in particular in the door closer, as an internal evaluation unit. The expression “in the door closer” is in particular to be understood in that the evaluation unit is located underneath the panel of the door closer. Alternatively, the evaluation unit can also be located next to the door closer, for example in the region of the door.

According to an optional second variant, it is provided that the evaluation unit generating the message is outsourced as an external evaluation unit, with the door closer being designed to send the actual angle of rotation or a value derived therefrom to the external evaluation unit-in particular by means of the data transmission unit, which is described below.

The door closer preferably comprises a module. The module has at least one battery and/or a data transmission unit.

The door closer is preferably designed without a connection to an external electrical power supply.

The sensor and/or the evaluation unit is/are preferably connected to the module for data and/or power transmission.

The at least one battery is preferably designed to supply power to the sensor unit and/or the data transmission unit. It is particularly preferably provided that the data transmission unit is designed to transmit a battery status of the at least one battery, for example a charge status. For example, the battery status can be transmitted to the external unit and/or the external evaluation unit.

If the evaluation unit is designed as an internal evaluation unit, the at least one battery is preferably provided to supply power to the evaluation unit.

The data transmission unit is preferably designed for wireless data transmission. If it is an external evaluation unit, the data transmission unit can send the actual angle of rotation or a value derived therefrom to the external evaluation unit. If it is an internal evaluation unit, the generated message can be sent to the external unit, for example the server or the terminal, via the transmission unit.

As mentioned, the door closer can comprise a panel that covers the housing of the door closer. The module is in particular located, preferably completely, under the panel. The module is particularly preferably fastened on the inside of the panel.

The module can preferably be fastened to one of the end walls of the panel, particularly preferably optionally to both end walls of the panel.

The module can preferably be arranged on both sides of the panel due to the optional left-sided arrangement and right-sided arrangement of the housing. For this reason, a module receptacle for fastening the module is preferably located on both end walls of the panel

Additionally or alternatively, the module can preferably be fastened on the mounting plate. The module can preferably be fastened to two opposing sides of the mounting plate.

The module can preferably be detached in a non-destructive manner, preferably without tools, from the panel and/or mounting plate, in particular for battery replacement.

The module preferably has a module circuit board. The module is fastened in particular by means of this module circuit board. The module circuit board is in particular fastened to the panel, preferably the module receptacle.

The module particularly preferably has a housing arrangement. This housing arrangement is in turn preferably fastened to the module circuit board. The housing arrangement is preferably designed to receive at least one battery.

The module is preferably fastened at a distance from the mounting plate. This distance can prove to be advantageous in the event of a fire if the mounting plate is heated via the door, as the distance prevents the heat from being transferred directly to the module and thus to the batteries. The distance is in particular chosen so that the at least one battery is at least 5 mm away from the mounting plate.

The housing has a first end face that faces a hinge on the door when the door closer is mounted. Furthermore, a second end face of the housing is defined, which is opposite the first end face. Accordingly, the second end face faces a main closing edge of the door. The module is preferably arranged next to the second end face of the housing.

The mounting plate, the housing and the module are preferably designed such that the housing can be fastened to the left and right sides of the mounting plate without rotating the mounting plate. In the left-sided arrangement, the hinges of the door are to the left of the door closer; in the right-sided arrangement, the hinges of the door are to the right of the door closer. The first end face must always face the hinges.

In the left-sided arrangement of the housing, the module is located to the right next to the housing above the mounting plate. In the right-sided arrangement of the housing, the module is located to the left next to the housing above the mounting plate. The module is in particular located completely above the mounting plate in both arrangements and therefore does not protrude laterally beyond the mounting plate.

The mounting plate and the housing are in particular designed such that the housing can be fastened on the mounting plate on the left side in one orientation and on the right side in a 180° rotated orientation.

As already mentioned, the door closer can comprise a transmission unit, which is located in the housing of the door closer and is designed to transmit the movement between the output shaft and the energy storage device. The transmission unit is in particular designed for reciprocal transmission between the rotational movement of the output shaft and the linear movement of the energy storage device.

The transmission unit preferably has a cam that rotates with the output shaft. The cam sits in particular on the output shaft and can be an integral component of the output shaft.

The cam is in particular heart-shaped and therefore has two convex flanks that converge in a depression.

The transmission unit preferably comprises a closing piston that is guided on the cam in a rolling or sliding manner. On the closing piston is located in particular a closing piston roller, which rolls on the cam. The closing piston is guided in particular in a linearly movable manner in the housing. The closing piston is in particular driven by the energy storage device. If the closing piston moves in one direction, it charges the energy storage device. When the energy storage device is discharged, the closing piston is pushed in the opposing direction by the energy storage device.

The closing piston is preferably guided on one flank of the cam. The flank runs into a depression of the cam, with the closing piston, in particular with its closing piston roller, resting against the flank and not against the depression when the output shaft is in the closed position. The closing piston moves along the flank in the direction of the depression when the actual angle of rotation moves into the second angle of rotation range.

It can be provided that the closing piston is located in the depression when the actual angle of rotation is located in the second angle of rotation range.

Two halves can be defined on the housing, with the first half being assigned to the first end face and the second half being assigned to the second end face. The output shaft is located in the first half and therefore closer to the first end face than to the second end face. The energy storage device is preferably located at least partially in the second half and therefore closer to the second end face than to the first end face. The energy storage device is therefore arranged between the output shaft and the second end face

The disclosure further comprises a method for operating a monitoring system, in particular the monitoring system described above. The advantageous configurations described for the monitoring system and the subclaims associated with the monitoring system find correspondingly advantageous application in the context of the method.

The method provides that the actual angle of rotation, which depends on the angle of rotation of the output shaft of the door closer, is detected. As described, the output shaft is used to fasten the lever arrangement. The output shaft is driven to rotate in the closing direction of rotation by the mechanical energy storage device of the door closer. The output shaft can be rotated into a first angle range, which can be used to open and close the door, and into a second angle range.

A message is generated if the actual angle of rotation is in the second angle range. A limit value, in particular the closing angle of rotation, separates the first angle range from the second angle range. The message is thus generated when the value falls below the limit value.

The closing angle of rotation in particular represents a closed position of the output shaft and thus a closed position of the door. The message is generated in particular by means of the described evaluation unit.

It is preferably provided as part of the method that a door closing time is monitored by means of the evaluation unit. This is possible, for example, by recording how long the actual angle of rotation changes in the closing direction of rotation until the closing angle of rotation is finally reached. If the recorded door closing time deviates from one or a plurality of limit values, a corresponding message is preferably issued. Based on this message, maintenance of the door closer, for example, can be considered. It may be that the door closing time is too short or too long.

In addition, it is preferably provided to monitor how long the door is open. This can also be done by regularly verifying the actual angle of rotation. A corresponding message is generated, in particular with the evaluation unit, if the door is open for longer than a predefined value. For example, the memory of the evaluation unit can store a maximum time duration during which the door may be open. The evaluation unit has a timer to measure the time duration. If the actual angle of rotation in the first angle range is above the closing angle of rotation for longer than the stored time period, a message is generated.

Furthermore, it is preferably provided that status messages are regularly generated. With the internal evaluation unit, these status messages can be generated in the door closer and sent to the external unit via the data transmission unit. In the case of an external evaluation unit, the status messages can also be generated within the door closer and transmitted to the external evaluation unit via the data transmission unit. The regular transmission of the actual angle of rotation or a value dependent thereon can also be regarded as a status message. The external unit, for example the server or the mobile terminal, is preferably used to generate a warning if the status message is missing and/or incorrect and/or has corresponding content.

In addition, it is preferably provided that an all-clear signal is generated if the actual angle of rotation, after being detected in the second angle of rotation range, is again in the first angle of rotation range. Additionally or alternatively, the all-clear message can be generated when a person acknowledges a corresponding warning, for example on the external unit described or on the door by actuating an operating element.

### BRIEF DESCRIPTION OF THE DRAWINGS

The disclosure will now be explained further on the basis of an exemplary embodiment, for which the following is shown:

FIG. 1 a schematic representation of a monitoring system according to the disclosure with an external evaluation unit and a door closer in accordance with an exemplary embodiment,

FIG. 1a a schematic representation of a variant of the monitoring system according to the disclosure with an internal evaluation unit in the door closer in accordance with the exemplary embodiment,

FIG. 2 a perspective view of the door closer of the monitoring system according to the disclosure in accordance with the exemplary embodiment,

FIG. 3 an exploded representation of the door closer of the monitoring system according to the disclosure in accordance with the exemplary embodiment,

FIG. 4 components inside a housing of the door closer of the monitoring system according to the disclosure in accordance with the exemplary embodiment,

FIG. 5 a schematic sectional view of a detail of the door closer of the monitoring system according to the disclosure in accordance with the exemplary embodiment,

FIG. 6 a perspective view of the door closer without panel of the monitoring system according to the disclosure in accordance with the exemplary embodiment,

FIG. 7 the section A-A marked in FIG. 2,

FIG. 8 a detail from FIG. 7,

FIG. 9 an end face of an output shaft of the door closer of the monitoring system according to the disclosure in accordance with the exemplary embodiment,

FIG. 10 a sensor receiving device of the door closer of the monitoring system according to the disclosure in accordance with the exemplary embodiment,

FIG. 11 a detail of the panel of the door closer of the monitoring system according to the disclosure in accordance with the exemplary embodiment,

FIG. 12 a variant of the sensor receiving device of the door closer of the monitoring system according to the disclosure in accordance with the exemplary embodiment,

FIG. 13 a perspective view of the door closer with open cover of the monitoring system according to the disclosure in accordance with the exemplary embodiment,

FIG. 14 a sectional view of a module in the door closer of the monitoring system according to the disclosure in accordance with the exemplary embodiment,

FIG. 15 a perspective view of the module of the door closer of the monitoring system according to the disclosure in accordance with the exemplary embodiment,

FIG. 16 a variant for configuring the module of the door closer of the monitoring system according to the disclosure in accordance with the exemplary embodiment,

FIG. 17 a sectional view of the variant of the module from FIG. 16,

FIG. 18 a variant for fastening the module of the door closer of the monitoring system according to the disclosure in accordance with the exemplary embodiment,

FIG. 19 different representations of the left-sided arrangement and right-sided arrangement of the housing of the door closer of the monitoring system according to the disclosure in accordance with the exemplary embodiment, with different components being hidden for the sake of clarity, and

FIG. 20 a method according to the disclosure.

### DETAILED DESCRIPTION OF THE DRAWINGS

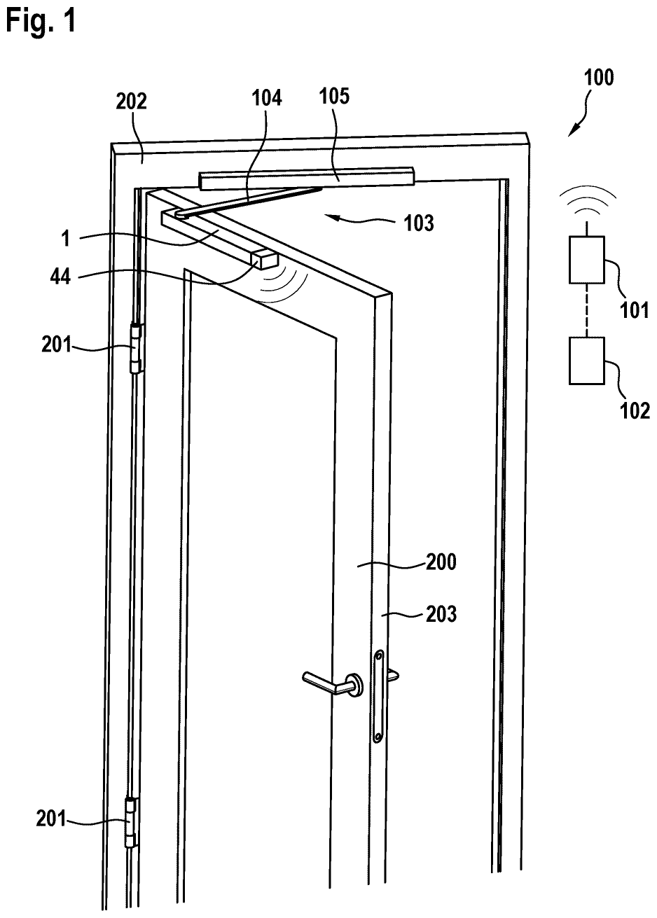

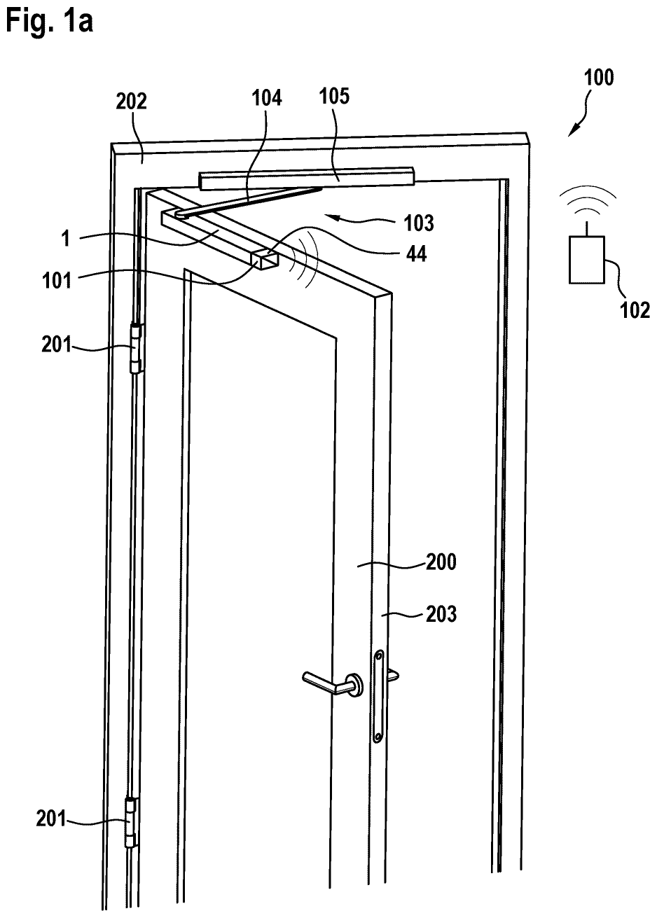

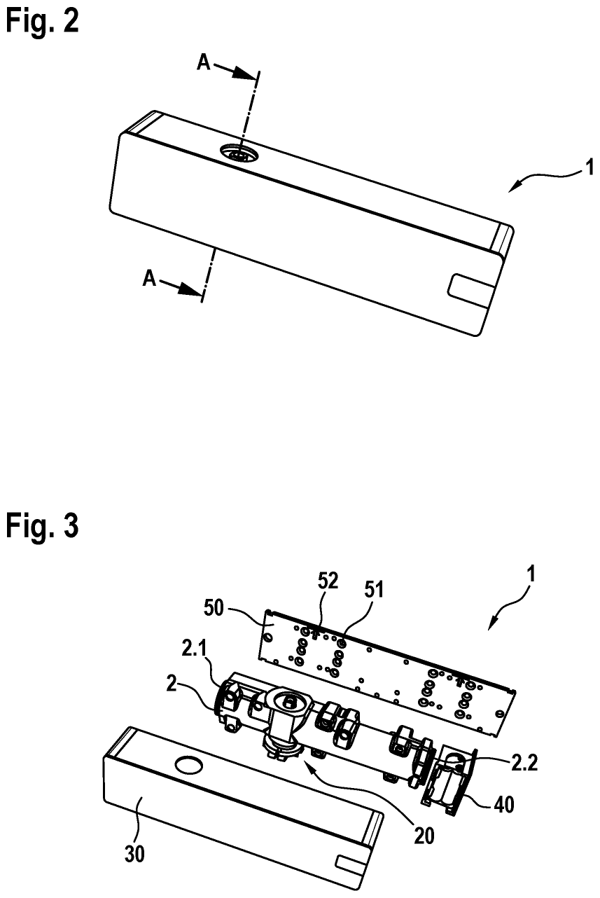

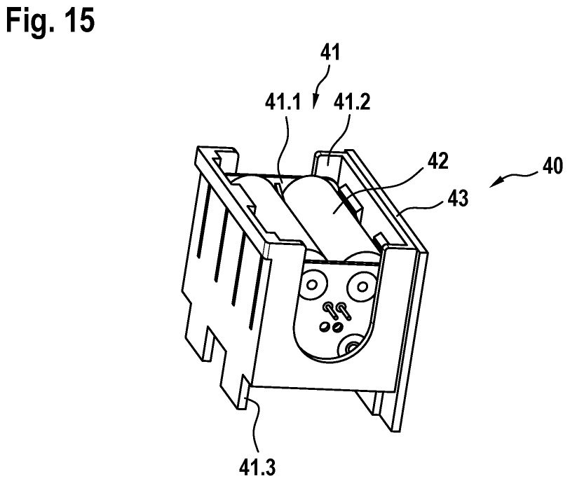

A monitoring system 100 with a door closer 1 will be described below on the basis of FIG. 1 to 19.

According to FIG. 1, the monitoring system 100 comprises an evaluation unit 101. In FIG. 1, the evaluation unit 101 is located outside the door closer 1 as an external evaluation unit 101. Alternatively, the evaluation unit 101 can also be a component of the door closer 1 as an internal evaluation unit 101—according to FIG. 1a.

Furthermore, the monitoring system 100 comprises an external unit 102, for example a server, a cloud, a building control unit, a terminal or a mobile terminal. The evaluation unit 101 and the external unit 102 are connected to one another for data transmission.

The door closer 1 comprises a data transmission unit 44. In FIG. 1, a wireless data transmission from this data transmission unit 44 to the external evaluation unit 101 is represented purely schematically. If the evaluation unit 101 is located inside the door closer 1 as an internal evaluation unit according to FIG. 1a, the data transmission unit 44 transmits wirelessly to the external unit 102.

The monitoring system 100 further comprises a lever arrangement 103. A lever 104 and a slide rail 105 are components of the lever arrangement 103.

According to FIG. 1, the door closer 1 is located on a door 200. Accordingly, the slide rail 105 is fastened to a wall 202. The lever 104 connects the door closer 1 with the slide rail 105 on the wall 202. As the schematic representation in FIG. 1 shows, the wall 202 is synonymous with the frame of the door 200.

The door 200 is supported so as to be rotatably movable relative to the wall 202 via two hinges 201.

Unless otherwise stated in detail, reference is always made below to all figures:

The door closer 1 has a housing 2. A first end face 2.1 and an opposing second end face 2.2 are defined on the housing 2 (see FIG. 3).

In addition to the housing 2, the door closer 1 has a mounting plate 50 and a panel 30. The housing 2 is fastened on the mounting plate 50. The mounting plate 50 comprises fastening elements 51 in the form of holes. The mounting plate 50 is used to fasten the door closer 1 to the door 200 or the wall 202. In addition, the door closer 1 comprises a module 40. FIG. 3 shows an exploded representation of these four assemblies, namely housing 2, module 40, panel 30 and mounting plate 50.

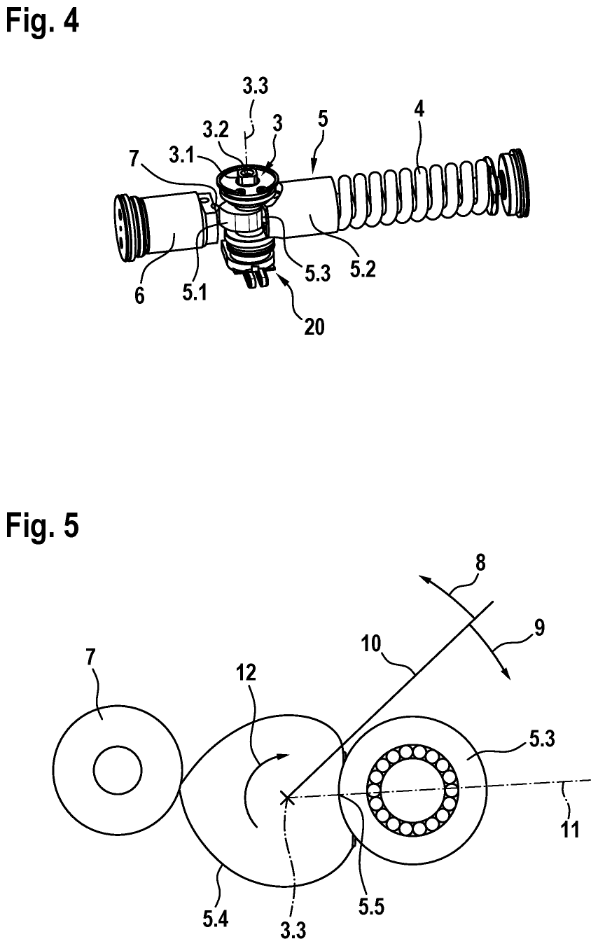

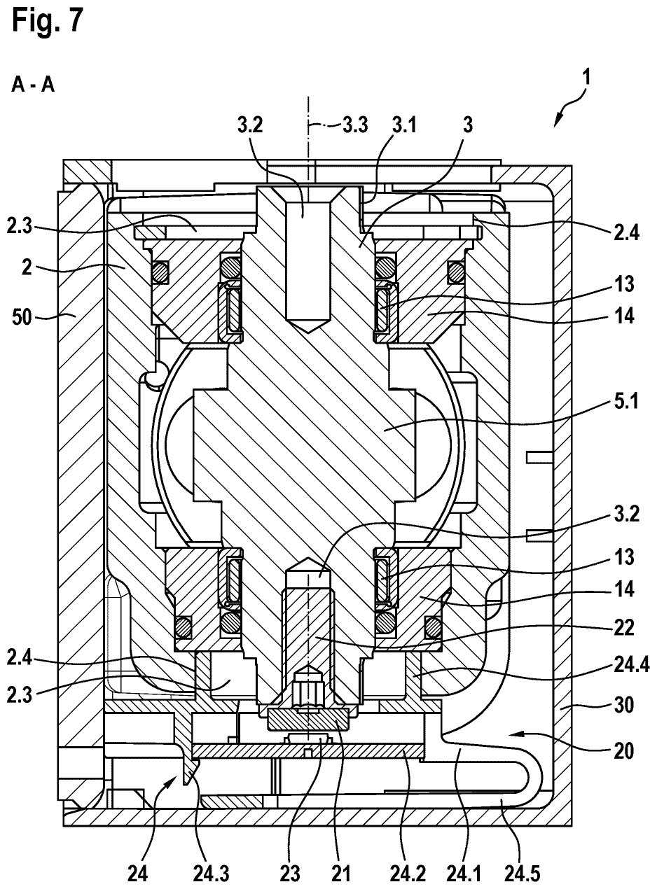

Furthermore, the door closer 1 has an output shaft 3. The output shaft 3 is supported in the housing 2 so as to be rotatably movable and is driven by an energy storage device 4 in the form of a spiral spring (see FIG. 4). As FIG. 7 in particular shows, the output shaft 3 is supported on both sides by means of an axle bearing 13. The axle bearing 13 is secured with a screwed-in axle bearing closure 14. This axle bearing closure 14 is regarded as a component of the housing 2.

The output shaft 3 is exposed on both sides (see FIG. 7) such that in principle the lever arrangement 103 can be fastened to the output shaft 3 on both sides. However, only one side of the output shaft 3 is actually used to fasten the lever arrangement 103. The respectively other side of the output shaft 3 is used to position a sensor unit 20 in the door closer 1.

The output shaft 3 has a polygon 3.1 on each of its two sides, in the form of a square. The output shaft 3 can be rotated about an axis of rotation 3.3. Coaxial to the axis of rotation 3.3, the output shaft 3 has a fastening receptacle 3.2 on both sides. The fastening receptacle 3.2 is in the form of a hole with an internal thread and is used to fasten the lever arrangement 103 or an encoder 21 of the sensor unit 20, as will be described in detail.

In FIG. 4, the housing 2 is hidden such that the internal components of the door closer 1 can be seen. Accordingly, the door closer 1 comprises a transmission unit 5 inside the housing 2. This transmission unit 5 has a cam 5.1 that rotates with the output shaft 3. A closing piston 5.2 is guided on the cam 5.1 in a rolling manner by means of a closing piston roller 5.3. The closing piston roller 5.3 rolls on a flank 5.4 of the cam 5.1. The schematic sectional view in FIG. 5 shows this in detail.

FIGS. 4 and 5 also show that a damping piston 6 is guided in the housing 2 in a linearly movable manner. This damping piston 6 also rolls on the cam 5.1 with a damping piston roller 7.

The cam 5.1 has two opposing flanks 5.4, which converge in a depression 5.5. The flanks 5.4 run convexly such that a heart-shaped cam 5.1 results.

In the representations according to FIGS. 4 and 5, the energy storage device 4 is in a discharged state. The closing piston roller 5.3 rests against the cam 5.1 inside the depression 5.5. This relative position between cam 5.1 and closing piston roller 5.3 only occurs if the door closer 1 is not yet installed or if the connection via the lever arrangement 103 is interrupted due to damage or tampering. However, if the door closer 1 is installed correctly and the connection between the door closer 1 and the wall 202 is ensured via the lever arrangement 103, the output shaft 3 is rotated relative to the representation in FIG. 5 such that the closing piston roller 5.3 rests outside the depression 5.5.

FIG. 5 illustrates purely schematically a closing direction of rotation 12 in which the output shaft 3 is rotated when the door 200 is closed. An opening direction of rotation runs counter to this closing direction of rotation 12 marked.

Furthermore, FIG. 5 shows purely by way of example a closing angle of rotation 10 of the output shaft 3, which separates a first angle range 8 and a second angle range 9. The closing angle of rotation 10 is represented here in simplified form only as a line, since in the context of the disclosure it is not important from which 0° position the closing angle of rotation 10 is measured, but rather that the closing angle of rotation 10 separates the first angle range 8 from the second angle range 9. The angle of rotation of the output shaft 3 marked by way of example is the actual angle of rotation 11—also represented in simplified form as a line. A reference leg of all angles of rotation, including the closing angle of rotation 10 and the actual angle of rotation 11, can in principle be placed at different positions, as only the relative values of the angles of rotation to each other are important.

According to the schematic representation in FIG. 5, the actual angle of rotation 11 lies in the second angle range 9. If the output shaft 3 is rotated counter to the closing direction of rotation 12, the actual angle of rotation 11 moves out of the second angle range 9, exceeds the closing angle of rotation 10 and reaches the first angle range 8. During normal use of the door, the actual angle of rotation 11 only moves in this first angle range 8.

In FIG. 5, the first angle range 8 is located in the half of the cam 5.1 shown above. The lower half of the cam 5.1 is not used in operation, but for this purpose, the door closer 1 would have to be in a different arrangement, e.g. in a left-sided arrangement instead of a right-sided arrangement.

The cam 5.1 is designed in particular such that the radius of the cam 5.1 decreases, in particular continuously, from the closing angle of rotation 10 as the limit value into the second angle range 9. As a result, the tensioned energy storage device 4 rotates the cam 5.1 from the closing angle of rotation 10 into the second angle of rotation range 9 via the closing piston 5.2, provided this is mechanically possible. However, when door closer 1 is mounted, the mounted lever arrangement 103 prevents this movement. Therefore, an angle of rotation in the second angle of rotation range 9 indicates that the door closer 1 and/or the lever arrangement 103 are not mounted correctly.

In other words: If damage or tampering occurs, in particular on the lever arrangement 103, the output shaft 3 rotates in the closing direction of rotation 12 due to the force exerted by the energy storage device 4 until the actual angle of rotation 11 is detected again in the second angle range 9.

A distinction can also be made as to whether the actual angle of rotation 11 corresponds to the closing angle of rotation 10 or occupies a position in the first angle of rotation range 8. The positions in the first angle of rotation range 8 correspond to an open door.

The evaluation unit 101 has a timer to measure a time duration. If the actual angle of rotation 11 in the first angle range exceeds a time duration stored in the evaluation unit 101, a message is generated.

Furthermore, the evaluation unit 101 can detect whether the actual angle of rotation 11 changes in the first angle of rotation range 8 and thus whether the door 200 is opened or closed. During a closing movement, the evaluation unit 101 can start the timer and measure the time period until the closing angle of rotation 10 is reached. If the door closing time obtained in this way is too short or too long, a message can be generated.

The sensor unit 20 is provided for detecting the actual angle of rotation 11. The exact configuration of the sensor unit 20 is shown in particular in FIGS. 3, 4 and 6 to 12. Accordingly, the sensor unit 20 comprises an encoder fastening 22 (see FIG. 7). The encoder fastening 22 is preferably made of plastic. The encoder fastening 22 is screwed into the fastening receptacle 3.2 of the output shaft 3.

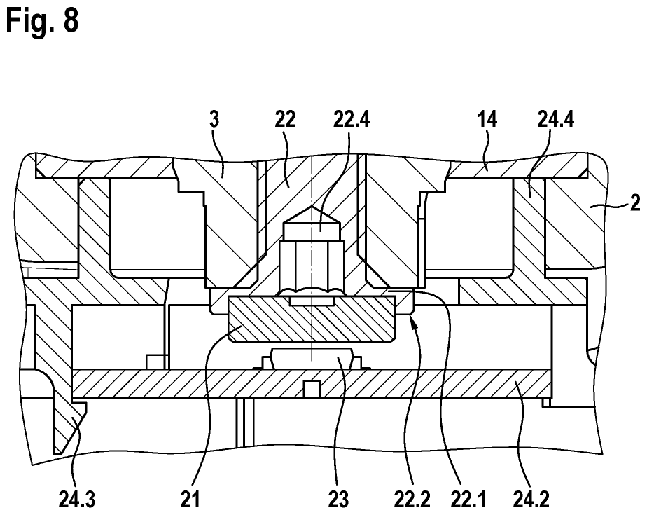

The encoder fastening 22 has a fastening head 22.1 (see FIG. 8). The encoder 21, in particular in the form of a permanent magnet, is fitted, in particular adhered, on this fastening head 22.1.

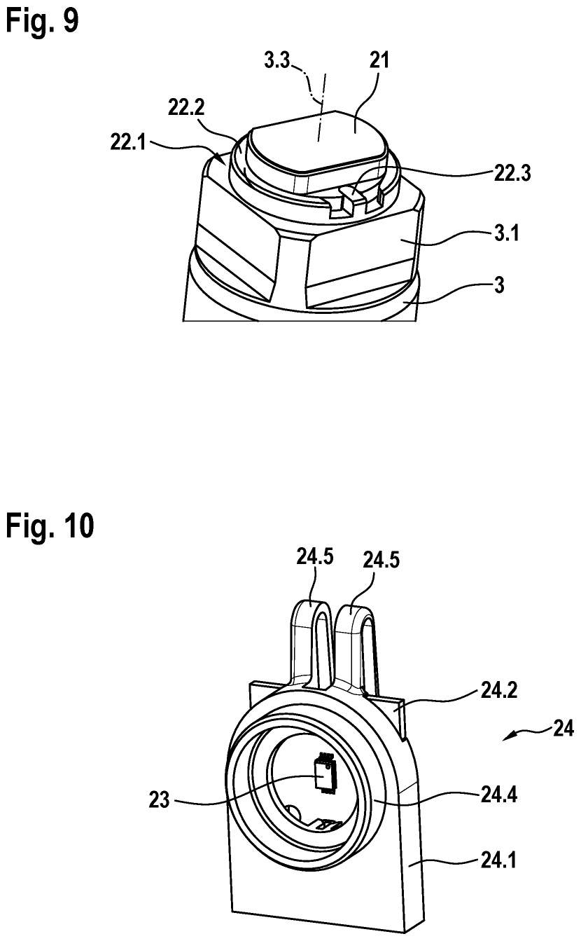

The fastening head 22.1 comprises an edge 22.2 and a form-fitting element 22.3 (see FIG. 9). The edge 22.2 surrounds the encoder 21. The form-fitting element 22.3 and the encoder 21 engage into one another. The edge 22.2 and/or the form-fitting element 22.3 allow the encoder 21 to be positioned precisely relative to the output shaft 3 and thus relative to the axis of rotation 3.3. This in particular ensures that the encoder 21 is arranged symmetrically to the axis of rotation 3.3.

The encoder fastening 22 can have a tool engagement 22.4, which in particular makes it easier to screw the encoder fastening 22 into the fastening receptacle 3.2.

A sensor 23 is located directly next to the encoder 21, but not touching the encoder 21. This sensor 23 is fastened to the end face of the output shaft 3 by means of a sensor receiving arrangement 24. The sensor receiving arrangement 24 is therefore directly on the housing 2.

The sensor receiving arrangement 24 comprises a bracket 24.1 and a sensor circuit board 24.2. The sensor 23 is located on this sensor circuit board 24.2. The sensor circuit board 24.2 is fastened by means of the bracket 24.1.

The bracket 24.1 has a bracket projection 24.4 (see FIGS. 7, 8, 10). This extends around the output shaft 3 so that the output shaft 3 protrudes into the bracket projection 24.4.

The bracket projection 24.4 is supported axially on the inside against the housing 2, in detail the axle bearing closure 14. This means that the bracket 24.1 rests against the housing 2. Radially outside, the bracket projection 24.4 clamps on an inner surface of the housing 2, whereby the bracket 24.1 is fastened to the housing 2.

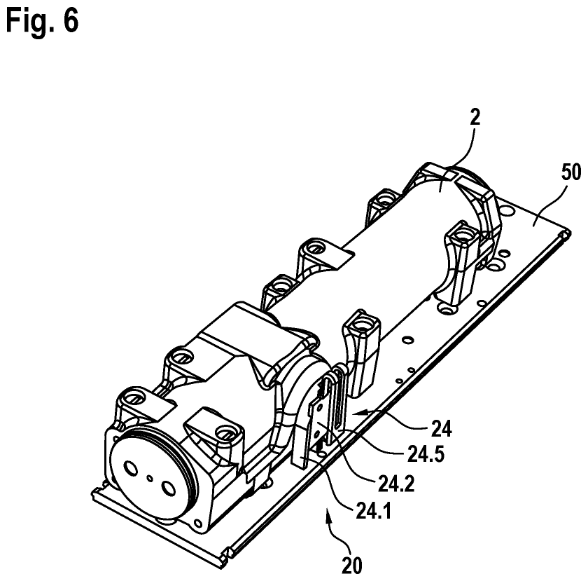

In addition, the figures, in particular FIG. 6, show that the bracket 24.1 has a fastening spring 24.5. The fastening spring 24.5 is located on the inside of the panel 30, whereby the bracket 24.1 is clamped between the panel 30 and the housing 2. This means that the sensor is positioned with as little play as possible in relation to the encoder 21.

The sensor receiving device 24, in particular the bracket 24.1, has a bracket clip 24.3 (see FIGS. 7 and 8). The sensor circuit board 24.2 is fastened to the bracket 24.1 by means of this bracket clip 24.3.

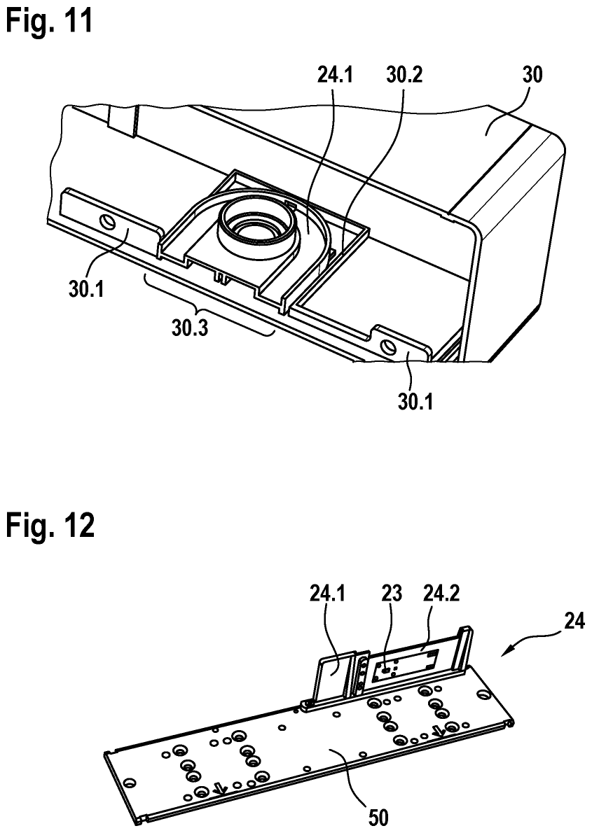

FIG. 11 in particular illustrates that the panel 30 has fastening tabs 30.1. The panel 30 can be fastened, in particular screwed, to the mounting plate 50 by means of these fastening tabs 30.1. Furthermore, FIG. 11 shows that the panel 30 has at least one bracket receptacle 30.2 on the inside. The bracket 24.1 protrudes into this bracket receptacle 30.2. It is in particular provided that a recess 30.3 without fastening tabs 30.1 is provided in the region of the bracket receptacle 30.2. This ensures that the fastening tabs 30.1 do not present an obstacle for the bracket 24.1 when the panel 30 is fitted.

FIG. 12 shows an alternative fastening of the sensor 23. The sensor 23 is also arranged on the sensor circuit board 24.2. The bracket 24.1 receives the sensor circuit board 24.2. However, the bracket 24.1 is designed such that it can be fastened, in particular screwed, directly on the mounting plate 50. This also makes it possible to fasten the sensor 23 directly to the end face of the output shaft 3 and thus directly to the encoder 21.

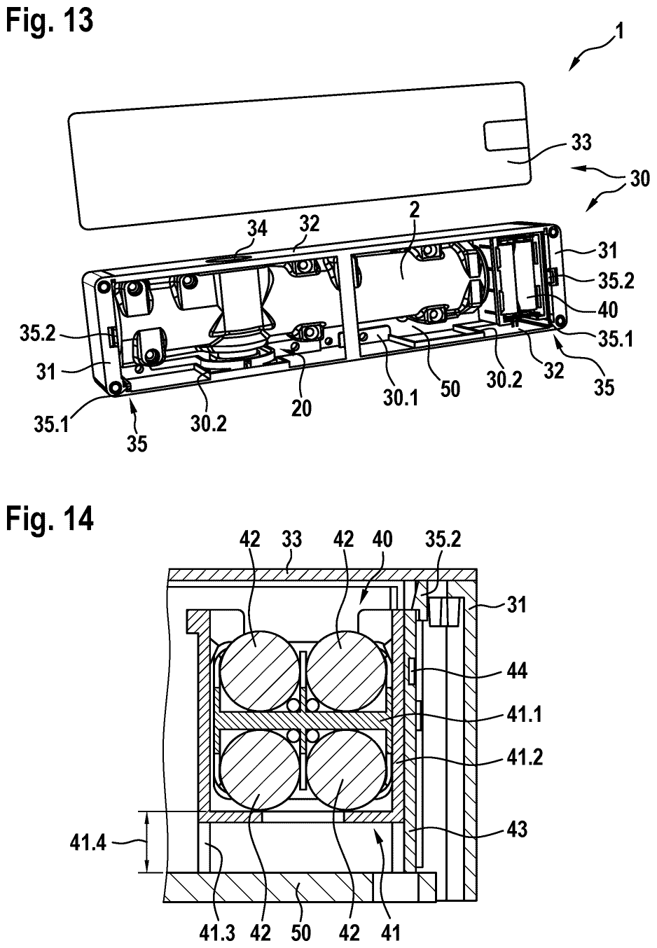

According to FIG. 13, the panel 30 has two opposing end walls 31. The end walls 31 are connected to one another via two opposing side walls 32. It is in particular provided that the two end walls 31 and the two side walls 32 together form the base body of the panel 30. This base body of the panel 30 can be closed by means of a cover 33.

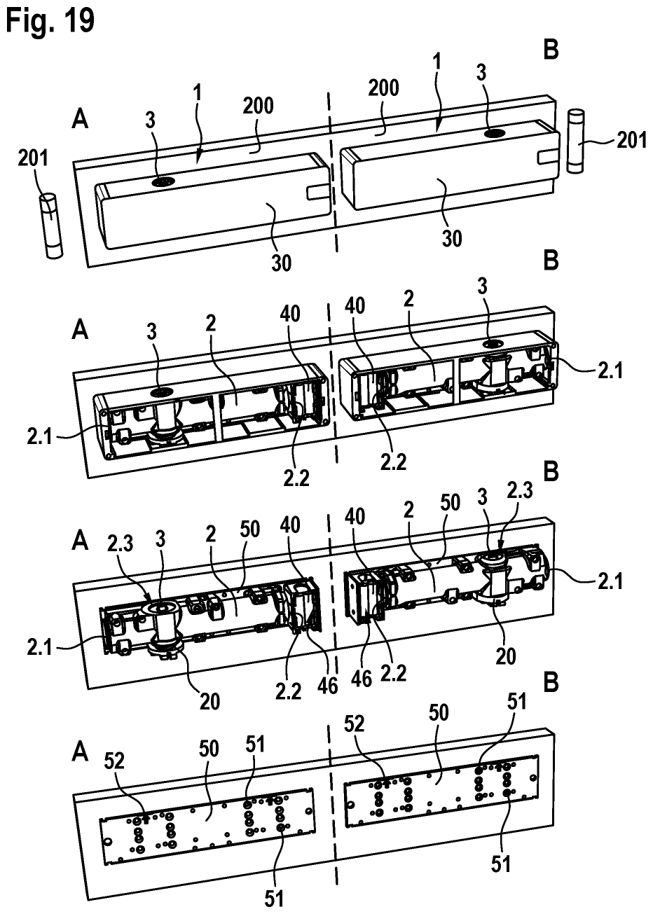

FIG. 13 shows the removed cover 33. It is easy to recognise that the described bracket receptacle 30.2 is doubled on the inside of one of the two side walls 32. This double design of the bracket receptacle 30.2 is used in particular when the housing 2 is changed between a left-sided arrangement A and a right-sided arrangement B, as will be explained in detail on the basis of FIG. 19.

The same applies to the represented axle recess 34 in FIG. 13. In the representation shown, the left axle recess 34 is used to connect the lever arrangement 103 to the output shaft 3. On the right side of the represented housing 30 is also provided an axle recess 34, which is closed, for example, by a blind cover not represented or can be broken out.

Furthermore, FIG. 13 shows the aforementioned module 40 inside the panel 30. This module 40 can also be arranged on both sides of the panel 30 due to the optional left-sided arrangement A and right-sided arrangement B of the housing 2. FIG. 13 therefore shows a module receptacle 35 on both end walls 31 of the panel 30. In the representation according to FIG. 13, the right module receptacle 35 is used.

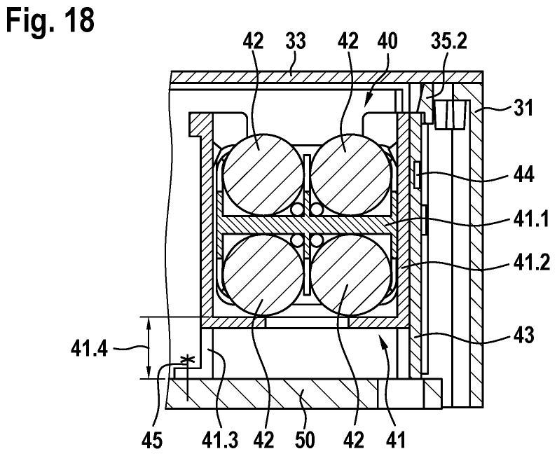

Each of the module receptacles 35 has a module groove 35.1 and a module clip 35.2. As will be described, the module 40 comprises a module circuit board 43. This can be inserted into the module groove 35.1 and fixed by means of the module clip 35.2. Alternatively (see FIG. 18), the module 40 is fastened, in particular screwed down, on the mounting plate 50. In this alternative, the module groove 35.1 and the module clip 35.2 can be omitted.

The module 40 has a housing arrangement 41. According to FIGS. 13 to 15, the housing arrangement 41 comprises an inner housing 41.1 and an outer housing 41.2. The inner housing 41.1 is used to directly receive batteries 42. The inner housing 41.1 is arranged in the outer housing 41.2. The outer housing 41.2 is fastened to the module circuit board 43 and additionally supported against the mounting plate 50 via spacers 41.3.

The spacers 41.3 secure a distance 41.4 (see FIG. 14) between the module 40 and the mounting plate 50. This distance 41.4 can prove to be advantageous in the event of a fire if the mounting plate 50 is heated via the door 200, as the distance 41.4 prevents the heat from being transferred directly to the module 40 and thus to the batteries 42.

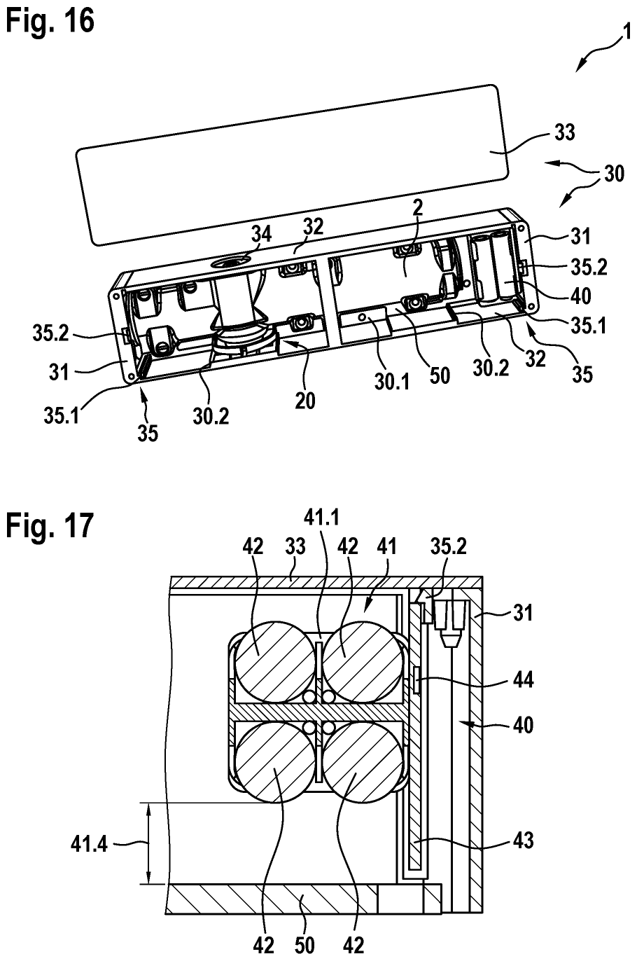

FIGS. 16 and 17 show a variant of the module 40. The housing arrangement 41 only has the inner housing 41.1. The inner housing 41.1 is used to directly receive the batteries 42. The inner housing 41.1 is fastened to the module circuit board 43. The distance 41.4 (see FIG. 17) is also maintained here.

FIG. 18 shows a variant for fastening the module 40 to the mounting plate 50. The housing arrangement 41 is fastened to the mounting plate 50 by means of a housing fastening 45, for example a screw. The module receptacle 35 can also be dispensed with. The module 40 can preferably be fastened to both sides of the mounting plate 50 by means of the housing fastening 45—due to the optional left-sided arrangement A and right-sided arrangement B of the housing 2.

The module 40 can be detached in a non-destructive manner in all the variants represented. For detachment without tools, the module clip 35.2 can be designed to be large enough for manual actuation. The housing fastening 45 can also be detachable without tools, e.g. by means of a wing screw.

As represented purely schematically in the FIGS. 14 and 17, 18, the data transmission unit 44 can be located in the module 40, for example in or on the module circuit board 43.

Two halves can be defined on the housing 2, with the first half being assigned to the first end face 2.1 and the second half being assigned to the second end face 2.2. The output shaft 3 is located in the first half and therefore closer to the first end face 2.1 than to the second end face 2.2. The energy storage device 4 is located at least partially in the second half and therefore closer to the second end face 2.2 than to the first end face 2.1.

As illustrated in particular by a combined view of, for example, FIG. 1 and FIG. 3, the first end face 2.1 faces the at least one hinge 201 of the door 200. Accordingly, the second end face 2.2 faces a main closing edge 203 of the door 200.

FIG. 19 illustrates in detail the already mentioned left-sided arrangement A of the housing 2 and the right-sided arrangement B of the housing 2. In the four illustrations in FIG. 19, components are gradually hidden in order to represent the complete structure clearly.

For the sake of clarity, FIG. 19 shows both arrangements A and B; in full knowledge that only one of these two arrangements is ever used on a door 200. For orientation, the first representation in FIG. 19 also shows the hinges 201 of the door 200. The first end face 2.1 of the housing 2 and thus half of the housing 2 with the output shaft 3 must always be assigned to these hinges 201.

FIG. 19 basically illustrates that the module 40 is arranged on the mounting plate 50 next to the second end face 2.2 of the housing 2. When changing between the left-sided arrangement A and the right-sided arrangement B, the mounting plate 50 is not rotated. The housing 2 is simply rotated such that the first end face 2.1 and the second end face 2.2 change their left-sided/right-sided orientation. The mounting plate 50, in particular with its fastening elements 51, is designed such that the housing 2 can be fastened on the mounting plate 50 both in the left-sided arrangement A and in the right-sided arrangement B in such manner that the module 40 is always located next to the second end face 2.2.

As FIG. 19 shows, for example, the mounting plate 50 can have an orientation indicator 52, for example in the form of arrows. This orientation indicator 52 indicates the orientation with which the mounting plate 50 must be fastened. The last representation in FIG. 19 makes it clear that the orientation indicator 52 is oriented in the same way for both the left-sided arrangement A and the right-sided arrangement B, which means that the mounting plate 50 does not have to be rotated.

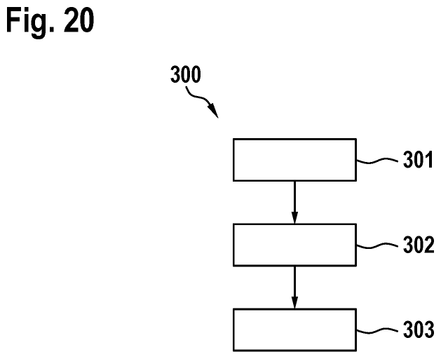

FIG. 20 shows a method 300 according to the disclosure. The method 300 according to the disclosure is preferably carried out with a monitoring system 100 as described above.

In a first step 301, the actual angle of rotation 11 is recorded. In a second step 302, the actual angle of rotation 11 is compared with a limit value, in particular with a closing angle of rotation 10. If the actual angle of rotation 11 is smaller than the limit value, for example, the actual angle of rotation 11 is in the second angle of rotation range 9. This causes a message to be generated by the evaluation unit 101 in a third step 303. However, if the comparison shows that the angle of rotation 11 is outside the second angle of rotation range 9, the message is cancelled.

The comparison between the actual angle of rotation 11 and the closing angle of rotation 10 preferably takes place in the evaluation unit 101. Alternatively, the actual angle of rotation 11 can of course also be greater than the limit value, in particular the closing angle of rotation 10, if the actual angle of rotation is in the second angle of rotation range 9. This is determined by the position of the reference leg.

For example, the closing angle of rotation 10 can depend on the thickness of a door 200.

The value of the closing angle of rotation 10 can be defined during commissioning. For this purpose, the evaluation unit 101 or the external unit 102 is in a commissioning mode. By means of a direct or indirect input, an installer can indicate that the door 200 is closed. The evaluation unit 101 and/or the external unit 102 can then adopt this measured actual angle of rotation 11 as the closing angle of rotation 10. The closing angle of rotation 10 can thus be taught-in.

Alternatively, the installer can determine the respective closing angle of rotation 10 depending on the installation situation. For example, a table may be present in which the closing angle of rotation 10 is indicated for different door thicknesses or for different door and/or frame geometries. The installer can, for example, enter the door thickness or the closing angle of rotation 10 via an input on the external unit 102.

Alternatively, the second angle of rotation range 9 or at least one limit value of the second angle of rotation range is already fixedly predefined in the evaluation unit 101 before installation. Since the closing piston 5.2 always runs into the depression 5.5 when the door closer 1 is not properly mounted on the door 200, it is not necessary to determine the exact closing angle of rotation 10. The second angle of rotation range 9 or the limit value of the second angle of rotation range 9 can, for example, be determined such that any possible closing angle of rotation 10 lies outside the second angle of rotation range 9. This makes it possible to electronically store the angle of rotation range 9 or a limit value of the angle of rotation range 9 in the evaluation unit 101 before commissioning.

1. A monitoring system comprising: a door closer for closing a door (200),
with a housing and an output shaft supported therein, designed for fastening a lever arrangement,
with a mechanical energy storage device in the housing, which drives the output shaft to rotate in a closing direction of rotation, wherein the energy storage device is preferably a spring, wherein the output shaft can be rotated into a first angle range, which can be used to open and close the door, and into a second angle range wherein the second angle range is not occupied by the output shaft if the door closer is properly installed on the door and in operation, and a limit between the first angle range and the second angle range represents a closed position of the output shaft,
with a sensor unit for detecting an actual angle of rotation dependent on the angle of rotation of the output shaft,
and an evaluation unit,
wherein the evaluation unit is designed to generate a message when the actual angle of rotation is in the second angle range,
wherein the door closer comprises a module with at least one battery, the second door closer is properly installed on the door and in operation
wherein the module comprises a module circuit board and the module is fastened by means of the module circuit board.

2. The monitoring system according to claim 1, wherein a closing angle of rotation is stored in the evaluation unit, which represents a closed position of the output shaft and separates the first angle range from the second angle range.

3. The monitoring system according to claim 1, wherein the door closer is designed to rotate the output shaft into the second angle range as soon as a connection between the output shaft and the door or between the output shaft and a wall is detached.

4. The monitoring system according to claim 1, wherein the output shaft in its closed position is driven by the energy storage device to rotate in the closing direction of rotation.

5. The monitoring system according to claim 1, wherein the sensor unit comprises a sensor and an encoder wherein the encoder is arranged or designed on the output shaft, wherein the sensor is designed and arranged to identify the encoder, in particular without contact, in particular a position and/or a rotation and/or an acceleration of the encoder, in order to detect the actual angle of rotation.

6. The monitoring system according to claim 5, wherein the encoder comprises a permanent magnet and wherein the sensor is a magnetic sensor, in particular a Hall sensor.

7. The monitoring system according to claim 5, wherein the encoder is fastened, preferably screwed, to the end face of the output shaft.

8. The monitoring system according to claim 5, wherein the axis of rotation of the output shaft intersects the sensor and/or the encoder; preferably wherein the sensor is arranged symmetrically to the axis of rotation and/or preferably wherein the encoder is arranged symmetrically to the axis of rotation.

9. The monitoring system according to claim 1, wherein
the output shaft is exposed on two opposing sides of the housing to optionally fasten the lever arrangement;
preferably comprising the lever arrangement, wherein the lever arrangement is fastened to the output shaft on one side and the encoder is fastened to the output shaft on the other side.

10. The monitoring system according to claim 5, wherein the sensor is arranged on a sensor receiving arrangement, in particular comprising a sensor circuit board, wherein preferably:
the door closer comprises a mounting plate and the housing of the door closer and the sensor receiving arrangement are fastened on the mounting plate,
and/or the sensor receiving arrangement is fastened to the housing of the door closer,
and/or the door closer comprises a panel which covers the housing of the door closer and the sensor receiving arrangement rests against the inside of the panel.

11. The monitoring system according to claim 1, wherein the evaluation unit is designed to relay the message to a unit, in particular building control unit and/or cloud and/or server and/or terminal and/or mobile terminal.

12. The monitoring system according to claim 1,
wherein the evaluation unit generating the message is arranged in the region of the door, in particular in the door closer, as an internal evaluation unit,
or wherein the evaluation unit generating the message is outsourced as an external evaluation unit, wherein the door closer is designed to send the actual angle of rotation or a value derived therefrom to the external evaluation unit.

13. The monitoring system according to claim 1, wherein the door closer comprises a data transmission unit, in particular designed for wireless data transmission.

14. The monitoring system according to claim 13, wherein:
the door closer comprises a panel which covers the housing of the door closer and the module is fastened to the inside of the panel,
and/or the door closer comprises a mounting plate and the housing of the door closer and the module are fastened on the mounting plate.

15. (canceled)

16. (canceled)
